(19) United States
(12) Patent Application Publication
(10) Pub. No.: US 2025/0385969 A1
(43) Pub. Date: Dec. 18, 2025

(54) INFORMATION PROCESSING SYSTEM, INFORMATION PROCESSING METHOD, AND PROGRAM

(71) Applicant: NTT TechnoCross Corporation, Tokyo (JP)

(72) Inventors: Hosana KAMIYAMA, Tokyo (JP); Takashi AOKI, Tokyo (JP); Kazuhira MATSUI, Tokyo (JP)

(73) Assignee: NTT TechnoCross Corporation, Tokyo (JP)

(21) Appl. No.: 18/879,000

(22) PCT Filed: Jun. 28, 2022
(86) PCT No.: PCT/JP2022/025843

§ 371 Date: Dec. 26, 2024

(51) Int. Cl. H04M 3/51; G10L 15/26

(52) U.S. Cl. CPC H04M 3/51; G10L 15/26

(57) ABSTRACT

An information processing system includes a display controller configured to display, in association with one another, a call text obtained by converting a voice call with a customer into a text through voice recognition, speaker information indicating a speaker of the call text, and time information indicating a date and time of the call text that was spoken; and a customer interaction record preparation unit configured to, in response to a user operation with respect to the time information, prepare the time information, and the call text and the speaker information each corresponding to the time information, as a customer interaction record with respect to the customer.

### TECHNICAL FIELD

The present disclosure relates to an information processing system, an information processing method, and a program.

### BACKGROUND ART

At contact centers (also referred to as call centers), a task called after call work (ACW) is generally performed. The after call work refers to a task to be performed after concluding a call with a customer to address his/her needs, i.e., a post-process, such as, for example, preparation of a memo called a customer interaction record (hereinafter may be referred to as a customer interaction record memo), and processing orders for goods or services. As a technique of increasing efficiency of such after call work, for example, the technique described in Non-Patent Document 1 is known.

### RELATED ART DOCUMENTS

### Non-Patent Documents

Non-Patent Document 1: ForeSight Voice Mining, Internet <URL: https://www.ntt-tx.co.jp/products/foresight_vm/>

### SUMMARY OF THE INVENTION

### Problem to be Solved by the Invention

However, in the related art, the customer interaction record memo cannot be fully utilized when a person other than the operator who interacted with the customer by telephone wishes to understand or analyze the contents of that call for some purposes (e.g., improvement in customer interaction quality). This is because in many cases, only the person who prepared the customer interaction record memo knows which part of the call the customer interaction record memo corresponds to.

Therefore, in order for a person other than the operator, who interacted with the customer by telephone, to understand or analyze the contents of the call, it is necessary to confirm the entire call, and as a result, it takes a great deal of time to understand or analyze the contents of the call.

The present disclosure has been made in view of the above, and provides a technique capable of utilizing a customer interaction record for a predetermined purpose.

### Means for Solving Problem

An information processing system according to an aspect of the present disclosure comprises: a display controller configured to display, in association with one another, a call text obtained by converting a voice call with a customer into a text through voice recognition, speaker information indicating a speaker of the call text, and time information indicating a date and time of the call text that was spoken; and a customer interaction record preparation unit configured to, in response to a user operation with respect to the time information, prepare the time information, and the call text and the speaker information each corresponding to the time information, as a customer interaction record with respect to the customer.

### Advantageous Effects of the Invention

The present disclosure provides a technique capable of utilizing a customer interaction record for a predetermined purpose.

### BRIEF DESCRIPTION OF THE DRAWINGS

FIG. 1 is a diagram illustrating an example of an entire configuration of a contact center system according to the present embodiment.

FIG. 2 is a diagram illustrating an example of a functional configuration of the contact center system according to the present embodiment.

FIG. 3 is a diagram illustrating an example of a data configuration of call history information.

FIG. 4 is a sequence diagram illustrating an example of a customer interaction record preparation process according to the present embodiment.

FIG. 5 is a diagram illustrating an example of a customer interaction record preparation screen.

FIG. 6 is a sequence diagram illustrating an example of a customer interaction record reference process according to the present embodiment.

FIG. 7 is a diagram (part 1) illustrating an example of a call content reference screen.

FIG. 8 is a diagram (part 2) illustrating an example of the call content reference screen.

FIG. 9 is a sequence diagram illustrating an example of a response support process according to the present embodiment.

FIG. 10 is a diagram (part 1) illustrating an example of a response support screen.

FIG. 11 is a diagram (part 2) illustrating an example of the response support screen.

FIG. 12 is a diagram (part 3) illustrating an example of the response support screen.

### EMBODIMENTS FOR CARRYING OUT THE INVENTION

Hereinafter, an embodiment of the present invention will be described. The present embodiment below is described using a contact center, specifically, a contact center system 1 configured to support utilization of customer interaction record memos for predetermined purposes (e.g., improvement in customer interaction quality, evaluation of operators, and the like). However, the contact center is merely an example, and the present invention is similarly applicable, for example, in supporting utilization of customer interaction record memos between a person in charge and a customer at an office or the like. More generally, the present invention is similarly applicable in supporting utilization of customer interaction record memos when one person responds to another person.

Here, the customer interaction record memo refers to a memo that represents a record when an operator conducts a call with a customer by telephone. In general, the customer interaction record memo is prepared in a task after a call with a customer, called the after call work. The content of the customer interaction record memo can be as desired, and various matters can be included.

Typical contents of the customer interaction record memo include, for example, contents of inquiries from customers, contents of operators' responses to the inquiries, concerns that are likely to lead to complaints and the like, requests for other operators and supervisors, and any other matter that should be noted.

### Entire Configuration of the Contact Center System 1

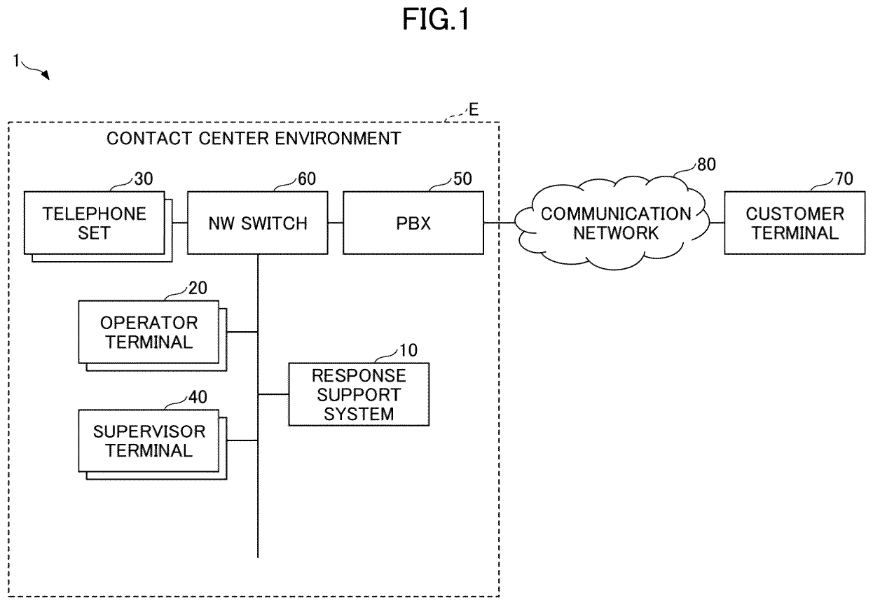

FIG. 1 is a diagram illustrating an example of the entire configuration of the contact center system 1 according to the present embodiment. As illustrated in FIG. 1, the contact center system 1 according to the present embodiment includes a response support system 10, a plurality of operator terminals 20, a plurality of telephone sets 30, one or more supervisor terminals 40, a PBX (Private Branch exchange) 50, a NW switch 60, and a customer terminal 70. Here, the response support system 10, the operator terminal 20, the telephone sets 30, supervisor terminals 40, the PBX 50, and the NW switch 60 are installed in a contact center environment E, which is a system environment of the contact center. The contact center environment E is not limited to a system environment in the same building, but may be, for example, system environments in a plurality of geographically separated buildings.

The response support system 10 is a server, a group of servers, or the like, configured to provide various functions for supporting the operators' responses by telephone and various related tasks. The functions provided by the response support system 10 are various, but in the present embodiment, the response support system 10 provides at least the following functions (1) to (4).

(1) Voice recognition function: A function of preparing a call text obtained by converting a voice call between an operator and a customer into a text annotated with time information, by using a packet (voice packet) transmitted from the NW switch 60.

(2) Customer interaction record memo preparation function: A function of preparing time information-annotated customer interaction record memo based on call text and time information to be annotated thereto.

(3) Customer interaction record memo reference function: A function of, upon referring to a customer interaction record memo, referring to call texts annotated with time information that precedes and succeeds the time information of the customer interaction record memo.

(4) Response support function: A function of, upon conducting a call with a customer by telephone, displaying call texts of the call with the customer in real time, and displaying customer interaction record memos of the previous calls with the customer.

By virtue of the functions described in (2) and (3) above, for example, it is possible to refer to not only a call text that was prepared into a customer interaction record memo, but also call texts that precede and succeed the call text. Thus, even a person other than the person who prepared the customer interaction record memo can understand or analyze the contents of the call in a relatively short time. Also, by virtue of the functions described in (2) to (4) above, it is possible to, upon conducting a call with a customer by telephone, refer to the customer interaction record memos of the previous calls with the customer. Thus, a high-quality response by telephone to be performed in consideration of the contents of the previous calls can be expected.

In addition to the above (1) to (4), the response support system 10 may provide various functions. For example, the response support system 10 may provide all or some of the following functions (5) to (10).

(5) Search function: A function of searching for call history information including various information of a call between an operator and a customer (e.g., call texts, customer interaction record memos, and the like of the call) and of providing search results to the operator terminal 20 and the supervisor terminal 40.

(6) Summarizing function: A function of preparing a summary from call texts of the entire call.

(7) Call monitoring function: A function of providing the supervisor terminal 40 with information for monitoring operators' calls (e.g., call texts of their calls, inappropriate language included in the call texts, and the like).

(8) Support request function: A function of operators' requesting a supervisor of support for their responses by telephone.

(9) Call text analysis function: A function of, using call texts, identifying a call reason (a reason for receiving a call), identifying whether the call is inbound or outbound, or identifying a situation (a situation of the call).

(10) Analysis function: A function of performing, from call history information, various analyses (e.g., analysis of customer interaction quality, and the like).

However, the functions described in (5) to (10) above are merely examples, and the response support system 10 may provide various other functions.

The operator terminal 20 is a terminal used by an operator, such as a PC (personal computer) or the like.

The telephone set 30 is an IP (Internet Protocol) telephone set used by an operator (e.g., a landline IP telephone set, a portable IP telephone set, or the like).

The supervisor terminal 40 is a terminal used by a supervisor, such as a PC or the like. The supervisor refers to, for example, a person who monitors operators' calls, and supports operators' responses by telephone when some problems are likely to occur or in accordance with requests by the operators. In general, calls of several to a dozen operators are monitored by one supervisor.

The PBX 50 is a telephone exchange (IP-PBX) and is connected to a communication network 80 including a VoIP (Voice over Internet Protocol) network and a PSTN (Public Switched Telephone Network).

The NW switch 60 relays packets between the telephone set 30 and the PBX 50, and captures the packets and transmits the captured packets to the response support system 10.

The customer terminal 70 is various terminals used by a customer, such as a smartphone, a mobile phone, a landline telephone, and the like.

The entire configuration of the contact center system 1 illustrated in FIG. 1 is merely an example, and other configurations may be possible. For example, in the example illustrated in FIG. 1, the response support system 10 is included in the contact center environment E (i.e., the response support system 10 is of an on-premise type). However, all or a part of the functions of the response support system 10 may be realized by a cloud service or the like. Similarly, in the example illustrated in FIG. 1, the PBX 50 is a telephone exchange of an on-premise type, but may be realized by a cloud service. When the operator terminal 20 has a telephone function, the contact center system 1 need not necessarily include the telephone sets 30.

### Functional Configuration of the Contact Center System 1

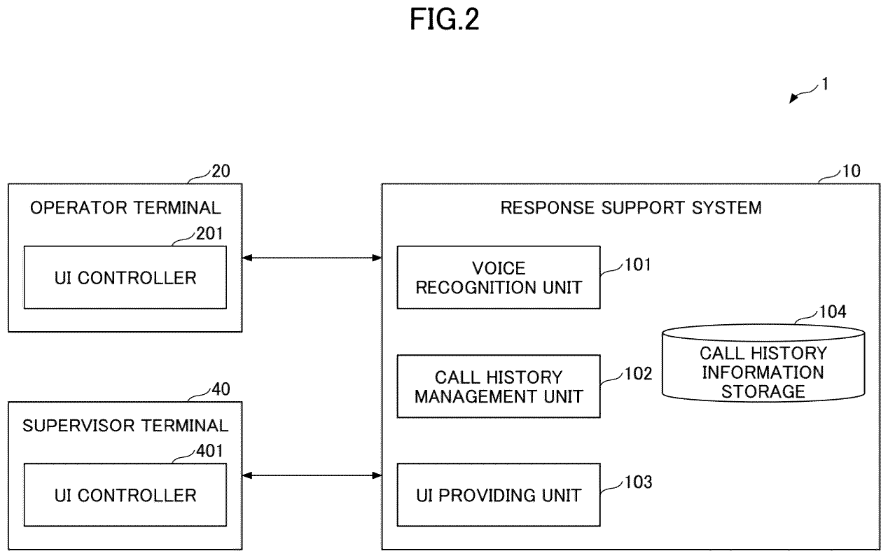

FIG. 2 illustrates a functional configuration example of the response support system 10, the operator terminal 20, and the supervisor terminal 40 included in the contact center system 1 according to the present embodiment.

### <<Response Support System 10>>

As illustrated in FIG. 2, the response support system 10 according to the present embodiment includes a voice recognition unit 101, a call history management unit 102, and a UI providing unit 103. Each of these units is realized, for example, through a process performed by a processor, such as a CPU (Central Processing Unit) or the like, that is executed in accordance with one or more programs installed in the response support system 10. The response support system 10 according to the present embodiment also includes a call history information storage 104. The call history information storage 104 can be realized, for example, by a storage device, such as an HDD (Hard Disk Drive), an SSD (Solid State Drive), a flash memory, or the like. The call history information storage 104 may be realized, for example, by a storage device or the like connected to the response support system 10 via a communication network.

The voice recognition unit 101 is configured to perform voice recognition on voice data included in a packet transmitted from the NW switch 60, thereby converting the voice represented by the voice data into a call text. Here, the voice recognition unit 101 is configured to convert the voice into a call text for each speaker (operator, customer), and prepare a call text annotated with time information for each speaker. The call text of one sentence (one phrase, one section, or the like of an utterance) is expressed in the form of: (Speaker information, Time information, Call text), for example. This call text can be prepared through a known voice recognition technique.

In the following, it is assumed that the call text is expressed in the form of (Speaker information, Time information, Call text). That is, it is assumed that the call text is annotated with the corresponding speaker information and the corresponding time information. The speaker information is information indicating the speaker (operator or customer) who utters voice speech corresponding to the call text. The time information is information indicating the time (date and time) when the voice speech corresponding to the call text is uttered.

The call history management unit 102 is configured to, at the end of a call between an operator and a customer, prepare call history information of the call and store the prepared call history information in the call history information storage 104. Also, the call history management unit 102 is configured to, when a customer interaction record memo of a call has been prepared in the ACW or the like, add the prepared customer interaction record memo to the call history information of the call.

The UI providing unit 103 is configured to provide screen information for displaying, on the operator terminal 20 or the supervisor terminal 40, various screens (e.g., below-described customer interaction record preparation screen, search screen, call content reference screen, response support screen, and the like). The screen information is expressed by information, such as HTML (Hypertext Markup Language), CSS (Cascading Style Sheets), JavaScript, or the like.

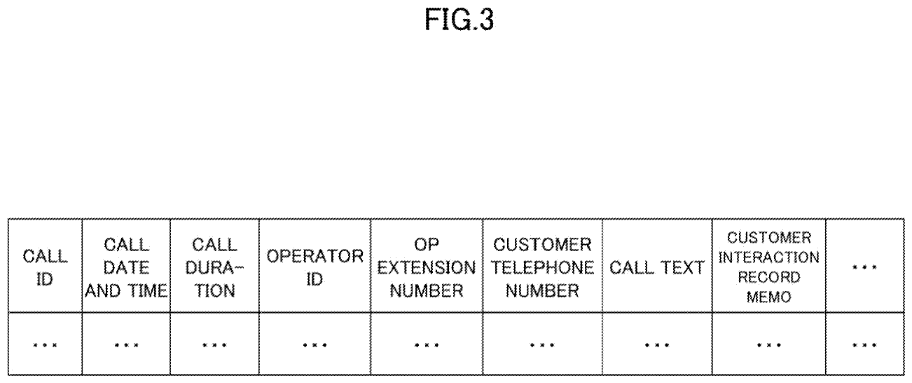

The call history information storage 104 is configured to store call history information. FIG. 3 illustrates an example of the data configuration of the call history information. As illustrated in FIG. 3, the call history information includes, for example, a call ID, a call date and time, a call duration, an operator ID, an OP extension number, a customer telephone number, a call text, a customer interaction record memo, and the like.

The call ID is identification information that uniquely identifies a call. The call date and time is a date and time when the call is started. The call duration is a duration from the start to the end of the call. The operator ID is identification information that uniquely identifies an operator who responds to the call. The OP extension number is an extension number of the operator who responds to the call. The customer telephone number is a telephone number of a customer in the call. The call text is a call text of the entire call. The customer interaction record memo is a customer interaction record memo of the call.

The data configuration of the call history information illustrated in FIG. 3 is merely an example. This is by no means a limitation. The call history information can include various information of the call (e.g., a call reason for the call, information indicating whether the call is inbound or outbound, each situation of the call, and the like).

### <<Operator Terminal 20>>

As illustrated in FIG. 2, the operator terminal 20 according to the present embodiment includes a UI controller 201. The UI controller 201 is realized, for example, through a process performed by a processor, such as a CPU or the like, that is executed in accordance with one or more programs (a Web browser or the like) installed in the operator terminal 20.

The UI controller 201 is configured to display, on the display of the operator terminal 20, various screens (e.g., a customer interaction record preparation screen, a search screen, a call content reference screen, a response support screen, and the like). The UI controller 201 is configured to receive various input operations from an operator on these various screens.

<<Supervisor terminal 40>>

As illustrated in FIG. 2, the supervisor terminal 40 according to the present embodiment includes a UI controller 401. The UI controller 401 is realized, for example, through a process performed by a processor, such as a CPU or the like, that is executed in accordance with one or more programs (a Web browser or the like) installed in the supervisor terminal 40.

The UI controller 401 is configured to display, on the display of the supervisor terminal 40, various screens (e.g., a search screen, a call content reference screen, and the like). The UI controller 401 is configured to receive various input operations from a supervisor on these various screens.

### Customer Interaction Record Preparation Process

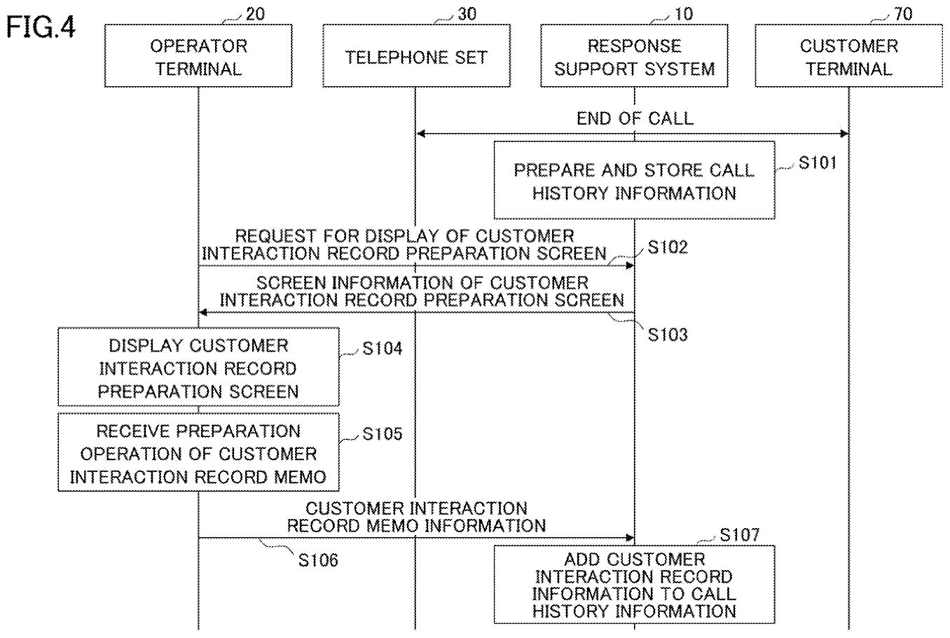

A customer interaction record preparation process for preparing a customer interaction record memo will be described below with reference to FIG. 4, assuming that an operator prepares a customer interaction record memo in the ACW or the like after the end of a call with a customer. The following is assumed to be in a state of being immediately after the end of a call with a customer.

The call history management unit 102 of the response support system 10 prepares call history information of the call and stores the prepared call history information in the call history information storage 104 (step S101). Note that the call history information does not include a customer interaction record memo (in other words, the call history information includes a customer interaction record memo in which a blank, a NULL value, or the like is set).

The UI controller 201 of the operator terminal 20 transmits, to the response support system 10, a request for display of a customer interaction record preparation screen (step S102). For example, the request for display of the customer interaction record preparation screen may be transmitted in response to an operator's operation or may be automatically transmitted after the end of a call with a customer.

When the UI providing unit 103 of the response support system 10 receives the request for display of the customer interaction record preparation screen, the UI providing unit 103 transmits, to the operator terminal 20, screen information of the customer interaction record preparation screen (step S103).

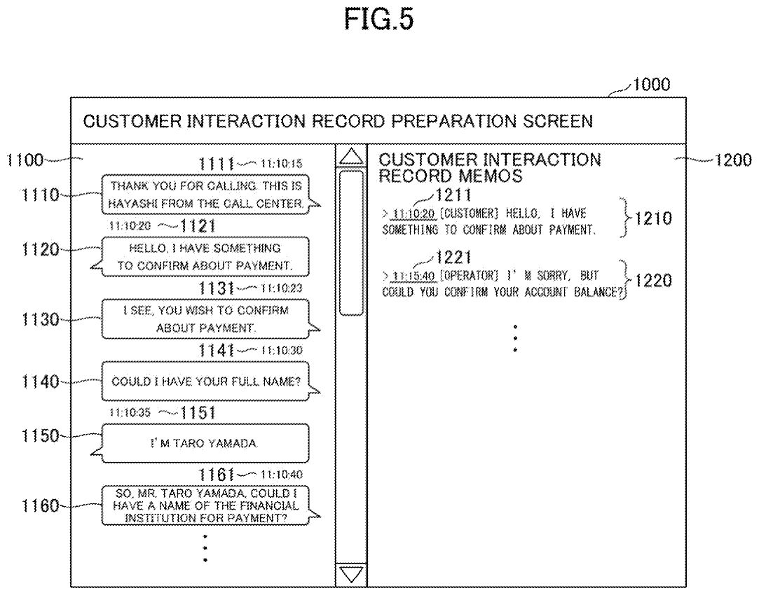

When the UI controller 201 of the operator terminal 20 receives the screen information of the customer interaction record preparation screen, the UI controller 201 displays the customer interaction record preparation screen on the display in accordance with the received screen information (step S104). An example of the customer interaction record preparation screen is illustrated in FIG. 5. A customer interaction record preparation screen 1000 illustrated in FIG. 5 includes a call text display field 1100 and a customer interaction record memo display field 1200.

The call text display field 1100 displays call texts of the entire call in time series for each speaker. In the example illustrated in FIG. 5, call texts 1110 to 1160 and time information 1111 to 1161 annotated to the call texts 1110 to 1160 are displayed. Also, in the example illustrated in FIG. 5, when the indication direction of a speech bubble, in which the call text is displayed, is rightward, the speaker of the call text is an operator, and when the indication direction of the speech bubble is leftward, the speaker of the call text is a customer. That is, the speaker of the call texts 1110, 1130, 1140, and 1160 is an operator, and the speaker of the call texts 1120 and 1150 is a customer.

The customer interaction record memo display field 1200 displays customer interaction record memos prepared by an operator. Here, by selecting time information displayed in the call text display field 1100 (e.g., clicking the time information using a mouse pointer or the like), an operator can prepare a customer interaction record memo including the selected time information, the speaker of a call text annotated with the selected time information, and the call text.

For example, by selecting time information 1121 in the call text display field 1100, a customer interaction record memo 1210 is prepared. The customer interaction record memo 1210 includes time information 1211 indicating the time information 1121, the speaker of a call text annotated with the time information 1121, i.e., “Customer”, and the call text “Hello, I have something to confirm about payment”.

Similarly, for example, by selecting time information “11:15:40” in the call text display field 1100, a customer interaction record memo 1220 is prepared. The customer interaction record memo 1220 includes time information 1221 indicating the time information “11:15:40”, the speaker of a call text annotated with the time information “11:15:40”, i.e., “Operator”, and the call text “I'm sorry, but could you confirm your account balance?”

In this manner, by selecting time information annotated to a call text, an operator can prepare a customer interaction record memo including at least the time information and the call text annotated with the time information. In addition to such a preparation method of a customer interaction record memo, an operator can also prepare a customer interaction record memo by inputting a text string into the customer interaction record memo display field using a keyboard or the like, in the same manner as in related art.

The description will be continued with reference to FIG. 4. Subsequent to step S104, the UI controller 201 of the operator terminal 20 receives a preparation operation of a customer interaction record memo (step S105). The preparation operation of the customer interaction record memo refers to, as described above, an operation to select time information annotated to a call text in the call text display field included in the customer interaction record preparation screen, an operation to input a text string into the customer interaction record memo display field, or the like.

The UI controller 201 of the operator terminal 20 transmits, to the response support system 10, customer interaction record memo information including the customer interaction record memo prepared in accordance with the preparation operation received in step S105, the call ID of the call, and the like (step S106).

When the call history management unit 102 of the response support system 10 receives the customer interaction record memo information, the call history management unit 102 adds the customer interaction record memo, included in the customer interaction record memo information, to the call history information of the call ID included in the customer interaction record memo information (step S107). Thus, the call history information including the customer interaction record memo is stored in the call history information storage 104. In the present embodiment, the customer interaction record memo is included in the call history information. This is by no means a limitation. For example, the customer interaction record memo information may be stored in a storage different from the call history information storage 104.

### Customer Interaction Record Reference Process

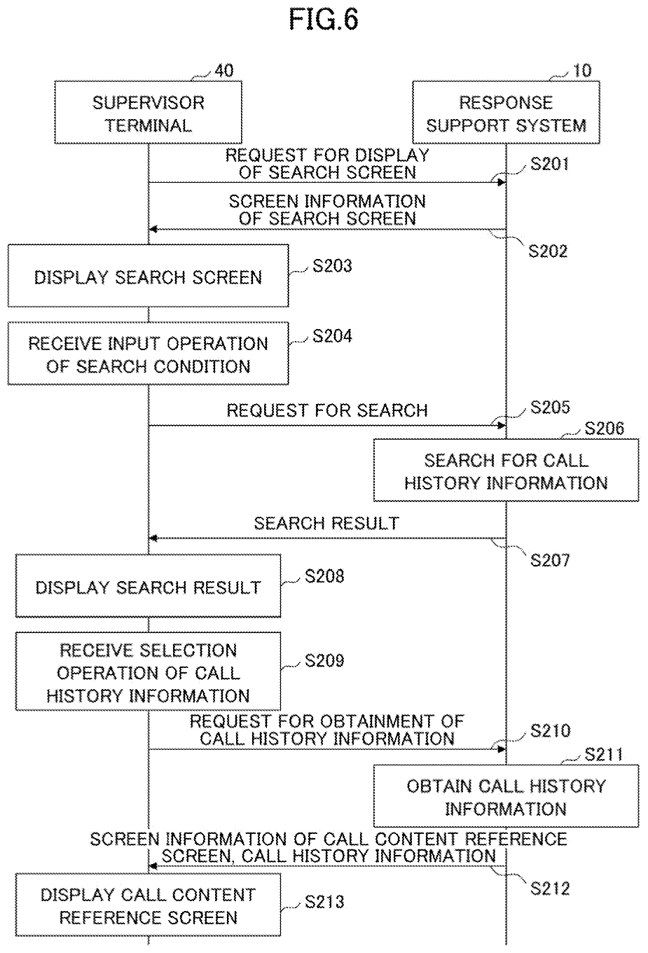

A customer interaction record reference process for referring to a customer interaction record memo will be described below with reference to FIG. 6, assuming that a supervisor refers to the customer interaction record memo of the previous call. In the following, it is assumed that the supervisor refers to the customer interaction record memo; however, by replacing “supervisor” with “operator”, “supervisor terminal 40” with “operator terminal 20”, and “UI controller 401” with “UI controller 201”, a process through which an operator refers to the customer interaction record memo of the previous call can be realized in the same manner.

The UI controller 401 of the supervisor terminal 40 transmits, to the response support system 10, a request for display of a search screen (step S201). The request for display of the search screen is transmitted, for example, in response to a supervisor's operation (e.g., an operation to display the search screen).

When the UI providing unit 103 of the response support system 10 receives the request for display of the search screen, the UI providing unit 103 transmits screen information of the search screen to the supervisor terminal 40 (step S202).

When the UI controller 401 of the supervisor terminal 40 receives the screen information of the search screen, the UI controller 401 displays the search screen on the display in accordance with the screen information (step S203). The search screen is a screen for inputting a search condition for searching for call history information, a screen for displaying search results for the search condition, or the like.

The UI controller 401 of the supervisor terminal 40 receives an input operation of a search condition (step S204). As the search condition, various conditions for searching for call history information can be input. For example, it is possible to input a condition related to information, such as a call ID, an operator ID, an operator's name, an operator's extension number, a customer's telephone number, a call date and time, a call duration, a situation, whether a call is inbound or outbound, a call reason, or the like.

The UI controller 401 of the supervisor terminal 40 transmits, to the response support system 10, the search condition received in accordance with the input operation in step S204 (step S205).

When the call history management unit 102 of the response support system 10 receives the search condition, the call history management unit 102 searches the call history information storage 104 in accordance with the received search condition (step S206).

The call history management unit 102 of the response support system 10 transmits, to the supervisor terminal 40, search results obtained in step S206 (step S207).

When the UI controller 401 of the supervisor terminal 40 receives the search results, the UI controller 401 displays the search results on the search screen (step S208). The supervisor can perform an operation to select desired call history information from among the search results displayed on the search screen. The search result is, for example, a call ID, a call date and time, a call duration, an operator ID, an operator's extension number, a customer number, or the like, of the call history information that satisfies the search condition. In addition, the search result may include, for example, a summary of the call text included in the call history information.

The UI controller 401 of the supervisor terminal 40 receives a selection operation of the call history information (step S209). The selection operation of the call history information is, as described above, an operation to select desired call history information from among the search results.

The UI controller 401 of the supervisor terminal 40 transmits, to the response support system 10, a request for obtainment of call history information (step S210). This request for obtainment includes, for example, the call ID of the call history information selected in accordance with the selection operation of the call history information.

When the call history management unit 102 of the response support system 10 receives the request for obtainment of the call history information, the call history management unit 102 obtains, from the call history information storage 104, call history information in accordance with this request for obtainment (e.g., call history information identified by the call ID included in the request for obtainment) (step S211).

The UI providing unit 103 of the response support system 10 transmits, to the supervisor terminal 40, screen information of a call content reference screen, and the call history information obtained in step S211 (step S212).

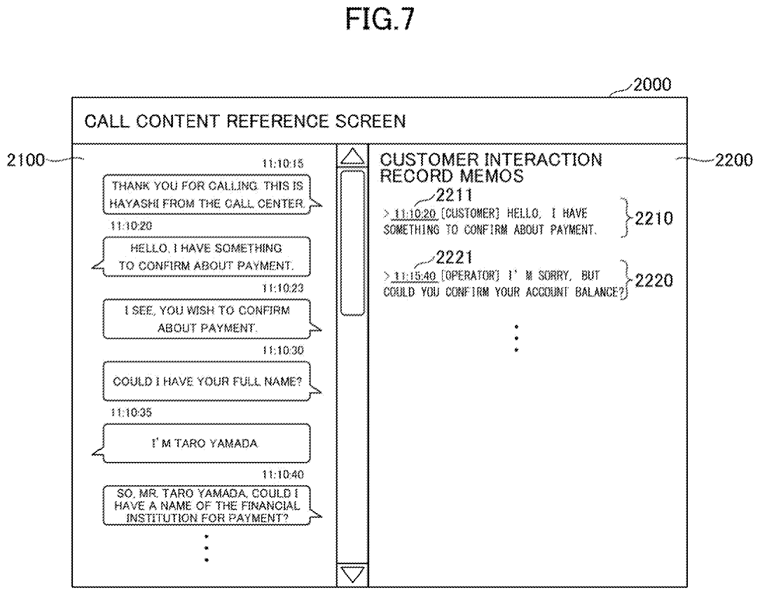

When the UI controller 401 of the supervisor terminal 40 receives the screen information of the call content reference screen and the call history information, the UI controller 401 displays the call content reference screen on the display in accordance with the received screen information and the received call history information (step S213). An example of the call content reference screen is illustrated in FIG. 7. A call content reference screen 2000 illustrated in FIG. 7 includes a call text display field 2100 and a customer interaction record memo display field 2200.

The call text display field 2100 displays call texts, included in the call history information, in time series for each speaker.

The customer interaction record memo display field 2200 displays customer interaction record memos included in the call history information. In the example illustrated in FIG. 7, a customer interaction record memo 2210 and a customer interaction record memo 2220 are displayed in the customer interaction record memo display field 2200.

By selecting time information in the customer interaction record memos (e.g., time information 2211, time information 2221, or the like), the supervisor can display, on the call text display field 2100, the call text annotated with the selected time information, and at least the call texts that precede and succeed the call text of the selected time information.

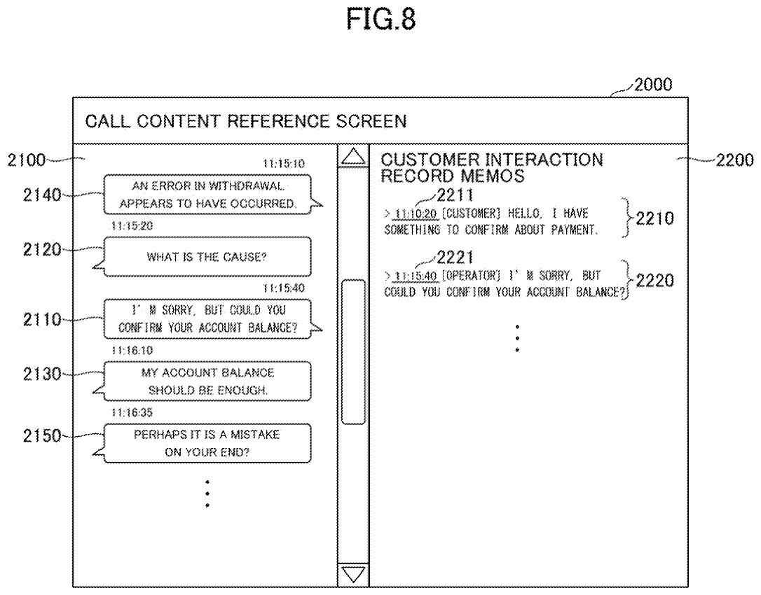

Here, as an example, FIG. 8 illustrates the call content reference screen 2000 when the time information 2221 in the customer interaction record memo 2220 is selected. The call text display field 2100 of the call content reference screen 2000 illustrated in FIG. 8 displays a call text 2110 annotated with the time information 2221 (i.e., time information “11:15:40”), call texts 2120 and 2130 that precede and succeed the call text of the time information 2221, and call texts 2140 and 2150 that further precede and succeed the call text of the time information 2221.

Thus, the supervisor can confirm not only the call text included in the customer interaction record memo, but also the call texts that precede and succeed that, and can readily understand a flow of the call that precedes and succeeds the call text included in the customer interaction record memo. Therefore, for example, the supervisor can understand, analyze, or the like the contents of the call in a relatively short time.

### Response Support Process

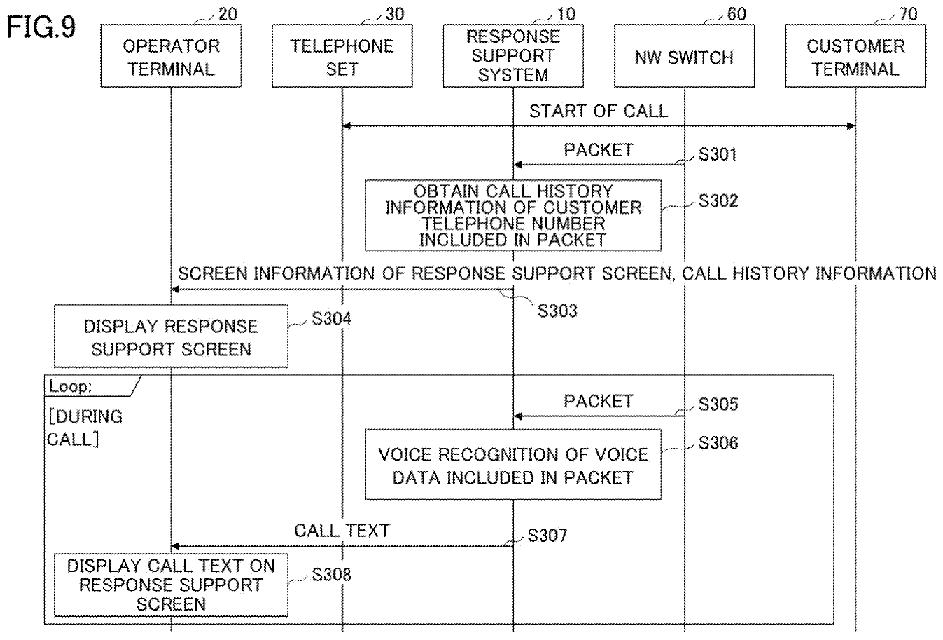

A response support process for supporting a response to a customer will be described below with reference to FIG. 9, assuming that an operator has started a call with the customer. The following is assumed to be in a state of being immediately after the start of the call.

The call history management unit 102 of the response support system 10 receives, from the NW switch 60, a packet of the call (a packet representing the start of the call) (step S301).

The call history management unit 102 of the response support system 10 obtains, from the call history information storage 104, call history information of a customer telephone number included in the packet (step S302).

The UI providing unit 103 of the response support system 10 transmits, to the operator terminal 20 of the operator, screen information of a response support screen, and the call history information obtained in step S302 (step S303).

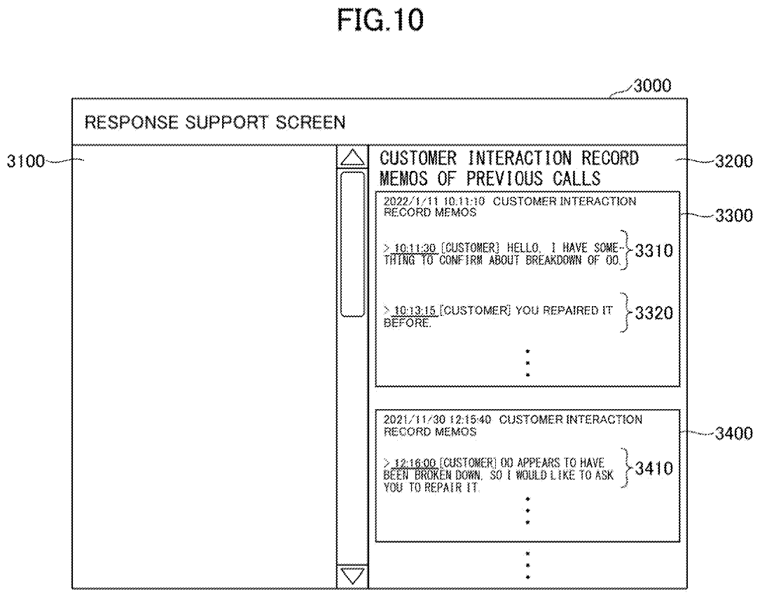

When the UI controller 201 of the operator terminal 20 receives the screen information of the response support screen and the call history information, the UI controller 201 displays the response support screen on the display in accordance with the received screen information and the received call history information (step S304). An example of the response support screen is illustrated in FIG. 10. A response support screen 3000 illustrated in FIG. 10 includes a call text display field 3100 and a customer interaction record memo display field 3200 of previous calls.

The call text display field 3100 displays call texts of the call in real time in time series for each speaker. The example illustrated in FIG. 10 is in a state of being immediately after the start of the call, and thus no call text is displayed.

The customer interaction record memo display field 3200 of previous calls includes previous call customer interaction memo display fields in which customer interaction record memos of the customer's previous calls (i.e., previous calls in which a customer telephone number is the same as the current call) are displayed. These previous call customer interaction memo display fields are displayed from top to bottom in order from that of the most recent previous call. The example illustrated in FIG. 10 includes a previous call customer interaction memo display field 3300 that displays customer interaction record memos of the previous call of “2022 Jan. 11 10:11:10” and a previous call customer interaction memo display field 3400 that displays customer interaction record memos of the previous call of “2021 Nov. 30 12:15:40”.

In the example illustrated in FIG. 10, the previous call customer interaction memo display field 3300 includes a customer interaction record memo 3310 and a customer interaction record memo 3320, and the previous call customer interaction memo display field 3300 includes a customer interaction record memo 3410.

In this manner, the response support screen displays customer interaction record memos of previous calls in which a customer telephone number is the same as that of the current call (especially, the response support screen displays from top to bottom in order from a customer interaction record memo of the most recent previous call). Thus, an operator can perform a response by telephone to a customer while confirming customer interaction record memos of previous calls with a customer the same as that in the current call, and, for example, can perform an appropriate response by telephone while considering, for example, the history of previous responses by telephone.

The description will be continued with reference to FIG. 9. Steps S305 to S308 of FIG. 9 are repeatedly performed in real time during a call with the customer.

The voice recognition unit 101 of the response support system 10 receives a packet of the call (voice packet) from the NW switch 60 (step S305).

The voice recognition unit 101 of the response support system 10 performs voice recognition on voice data included in the packet received in step S305, thereby preparing a call text (a call text annotated with time information for each speaker) (step S306).

The voice recognition unit 101 of the response support system 10 transmits, to the operator terminal 20, the call text prepared in step S306 (step S307).

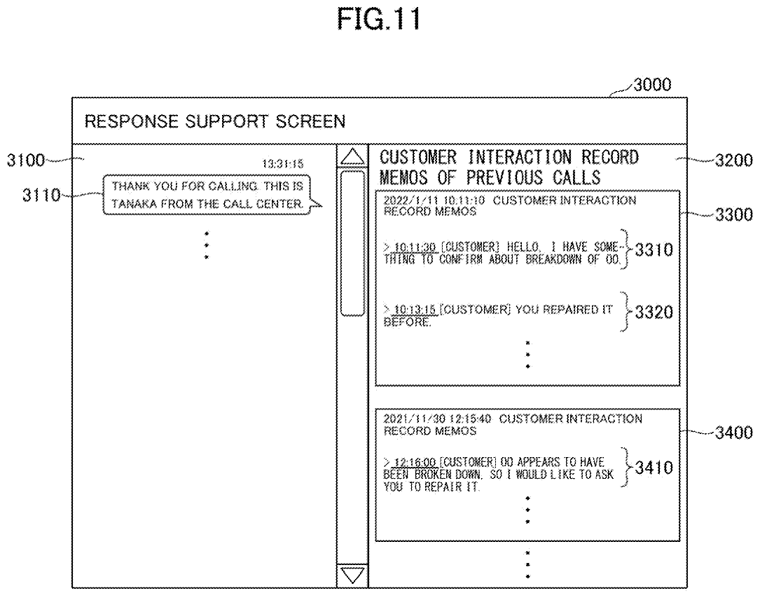

When the UI controller 201 of the operator terminal 20 receives the call text, the UI controller 201 displays the received call text on the call text display field of the response support screen (step S308). For example, when the call text is expressed as: (13:31:15, Operator, Thank you for calling. This is Tanaka from the call center.), a call text 3110 is displayed on the call text display field 3100 of the response support screen 3000, as illustrated in FIG. 11. In this manner, every time a call text is received, the received call text is displayed in real time on the call text display field of the response support screen.

Here, an operator sometimes wishes to confirm call texts that precede and succeed a call text in a customer interaction record memo of a previous call, and a flow of a conversation when the call text was spoken. In such a case, by selecting time information in a previous customer interaction record memo (or mouse-over with respect to time information may be performed), the operator can refer to call text annotated with the selected time information in the previous call, and at least the call texts that precede and succeed the call text of the selected time information.

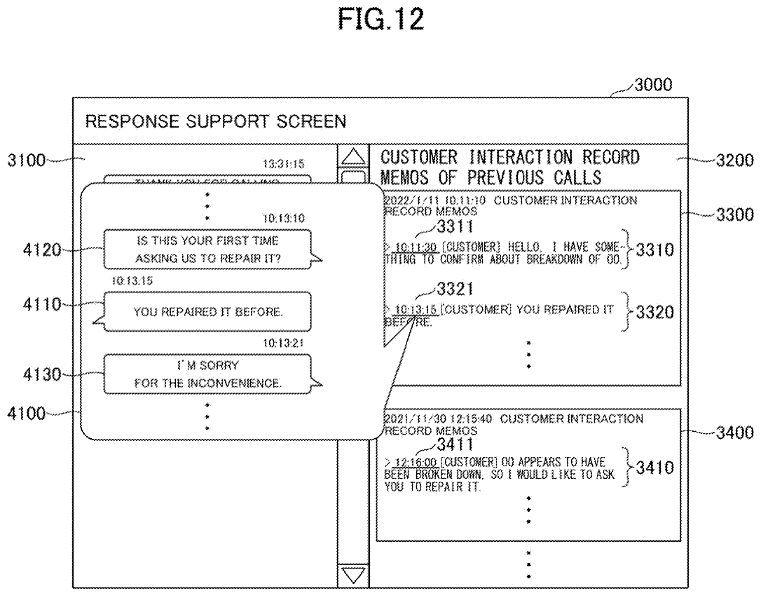

For example, according to the response support screen 3000 illustrated in FIG. 12, by selecting time information 3311 in the customer interaction record memo 3310, time information 3321 in the customer interaction record memo 3320, and time information 3341 in the customer interaction record memo 3410, it is possible to refer to a call text annotated with the selected time information in a specific previous call and at least call texts that precede and succeed the call text of the selected time information. Specifically, for example, when the time information 3321 is selected, a speech bubble window 4100 pops up. The speech bubble window 4100 displays call text 4110 annotated with the time information 3321 (i.e., time information “10:11:30”) in the previous call of “2022 Jan. 11 10:11:10”, and call texts 4120 and 4130 that precede and succeed the call text of the time information 3321. As a result, an operator can confirm not only the call text in the customer interaction record memo of a previous call with a customer the operator is currently responding to during the present call, but also call texts that precede the call text and call texts that succeed the call text. This enables an effective response by telephone in consideration of the contents of the previous call according to these call texts.

An operator can also perform, for example, a scroll operation in the speech bubble window by using a mouse wheel or the like. As a result, the operator can display a call text in the past or future of the call text currently displayed in the speech bubble window.

### SUMMARY

As described above, according to the contact center system 1 according to the present embodiment, simply by selecting time information annotated to a call text, an operator can prepare the call text into a customer interaction record memo. Therefore, the operator can readily prepare a customer interaction record memo, and, for example, the time required for the ACW can be reduced.

Also, according to the contact center system 1 according to the present embodiment, by selecting time information in a customer interaction record memo, it is possible to refer to a call text annotated with the selected time information in a call of interest, and call texts including at least the call texts that precede and succeed the call text. Thus, an operator or supervisor can readily confirm a flow of the call that precedes and succeeds the call text included in the customer interaction record memo, and as a result, can understand, analyze, or the like the contents of the call in a relatively short time.

The present invention is not limited to the above specifically disclosed embodiments. Various modifications, alterations, combinations with existing techniques, and the like are possible without departing from the claims recited.

### REFERENCE SIGNS LIST

1 Contact center system
10 Response support system
20 Operator terminal
30 Telephone set
40 Supervisor terminal
50 PBX
60 NW switch
70 Customer terminal
80 Communication network
101 Voice recognition unit
102 Call history management unit
103 UI providing unit
104 Call history information storage
201 UI controller
401 UI controller
E Contact center environment

1. An information processing system, comprising:
a memory; and
at least one processor connected to the memory, wherein the processor is configured to:
display, in association with one another, a call text, speaker information, and time information, wherein the call text represents a text that is converted from voice data of a voice call with a customer through voice recognition, the speaker information indicates a speaker of the call text, and the time information indicates a date and time of the call text that was spoken; and
generate, based on an interactively received selection of the time information, a customer interaction record of the customer, wherein the customer interaction record comprises the time information, the call text corresponding to the time information, and the speaker information corresponding to the time information.

2. The information processing system according to claim 1, wherein
the processor is configured to
in response to the interactive selection of the time information in the customer interaction record, display at least the call text, a preceding call text, and a subsequent call text, wherein the preceding call text precedes the call text according to the time information during the voice call in the customer interaction record, and the subsequent call text succeeds the call text according to the time information during the voice call in the customer interaction record.

3. The information processing system according to claim 1, wherein
the processor is configured to
when the voice call with the customer is underway, display the call text and the customer interaction record, wherein the call text represents output of converting the voice call into the text through voice recognition in real time, and the customer interaction record is of a previous voice call with the customer.

4. The information processing system according to claim 3, wherein
the processor is configured to
in response to the interactive selection of the time information in the customer interaction record of the previous voice call, display at least the call text, a preceding call text, and a subsequent call text, wherein the preceding call text precedes the call text according to the time information during the previous voice call in the customer interaction record, and the subsequent call text succeeds the call text according to the time information during the previous voice call in the customer interaction record.

5. An information processing method, comprising:
displaying, in association with one another, a call text, speaker information, and time information, wherein the call text represents a text that is converted from voice data of a voice call with a customer through voice recognition, the speaker information indicates a speaker of the call text, and the time information indicates a date and time of the call text that was spoken; and
generating, based on an interactively received selection of the time information, a customer interaction record of the customer, wherein the customer interaction record comprises the time information, the call text corresponding to the time information, and the speaker information corresponding to the time information.
the displaying and the generating being performed by a computer.

6. A non-transitory computer-readable recording medium storing a program that causes a computer to execute:
displaying, in association with one another, a call text, speaker information, and time information, wherein the call text represents a text that is converted from voice data of a voice call with a customer through voice recognition, the speaker information indicates a speaker of the call text, and the time information indicates a date and time of the call text that was spoken; and
generating, based on an interactively received selection of the time information, a customer interaction record of the customer, wherein the customer interaction record comprises the time information, the call text corresponding to the time information, and the speaker information corresponding to the time information.
